(19) United States
(12) Patent Application Publication
(10) Pub. No.: US 2007/0050437 A1
(43) Pub. Date: Mar. 1, 2007

(54) Systems and methods for random value generation

(75) Inventors: Jeanne Krayer Pitz, Richardson, TX (US); Ted Lekan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/212,835

(22) Filed: Aug. 25, 2005

(51) Int. Cl. G06F 7/58

(52) U.S. Cl. 708/250

(57) ABSTRACT

Systems, methods and circuits for generating random numbers. As one example, a system for generating random numbers is disclosed that includes an analog to digital conversion element that provides an output, and a digital filter that is electrically coupled to the analog to digital conversion element and provides an information signal based at least in part on the output. In addition, the system includes a memory device electrically coupled to a sequencer that generates a capture signal. The memory is operable to capture the information signal based at least in part on the capture signal.

### BACKGROUND OF THE INVENTION

The present invention is related to systems and methods for random number generation, and in particular to systems and methods for generating a random number associated with an analog electrical input.

Random numbers are used in various different applications. For example, in an iterative estimation program it is often desirable to start with a random number and iteratively proceed to converge on a desired estimate. Other examples include software games designed to place a user in a randomly selected environment, and cryptography applications where random numbers are used as a key for encrypting information. The quality or randomness of numbers necessary for effective operation of a given application varies, and in some cases the inability to generate a number that is truly random limits the efficacy of a particular system. For example, a computerized gambling system or a cryptographic security system relying upon a random number is susceptible to malicious activity if the random number is deterministic or predictable.

Existing random number generators vary in the quality or randomness of generated random numbers. Indeed, in some cases, a generator is called pseudo-random number generator in recognition of its limited capability. Random number generation has been done in both hardware and software. For example, a software algorithm may be designed to produce random numbers, however, two equal software algorithms will most likely generate the same random number when operated under common conditions. Thus, while they provide numbers that superficially appear random, an understanding of the software algorithm will often lead to at least a degree of predictability. Hardware random number generators typically rely on digital hardware including timers and the like. While such hardware generators may be less predictable than the aforementioned software algorithms, they are often still predictable.

Hence, for at least the aforementioned reason, there exists a need in the art for alternative systems and methods for generating random numbers.

### BRIEF SUMMARY OF THE INVENTION

The present invention is related to systems and methods for random number generation, and in particular to systems and methods for generating a random number associated with an analog electrical input.

Some embodiments of the present invention provide systems for generating random numbers that include an analog to digital conversion element that provides an information signal. In addition, the system includes a memory device electrically coupled to a sequencer that generates a capture signal. The sequencer asserts the capture signal at a time when information associated with the information signal is random or unpredictable. The memory is operable to store the information associated with the information signal upon assertion of the capture signal. In some instances, the analog to digital conversion element includes a sigma delta modulator. In one or more instances, the analog to digital conversion element includes a digital filter. In one particular case, the digital filter is a third order decimation filter. In such a case, the information signal may be derived from an output of a stage of the third order decimation filter. Further, some instances include a power source that is electrically coupled to the analog to digital conversion element and the sequencer. In such instances, the sequencer is operable to assert the capture signal at a predetermined point after activation of the power source. The sequencer may include a counter driven by a clock, and the predetermined point after activation of the power source may be a number of clock cycles recognized by the counter. In some cases, the point after activation of the power source is prior to stabilization or steady state operation of the analog to digital conversion element.

Other embodiments of the present invention provide methods for generating random numbers. Such methods include electrically coupling a filter that generates an information signal to a sigma delta modulator, and electrically coupling the filter to a memory. In addition, the methods include electrically coupling a sequencer that generates a capture signal to the memory. A derivative of the capture signal and a derivative of the information signal is provided to the memory device, and information associated with the derivative of the information signal is stored in the memory based at least in part on the derivative of the capture signal. In some cases, the derivative of the capture signal is received directly from the sequencer and is the same as the capture signal. In other cases the derivative of the capture signal is a modified version of the capture signal provided by the sequencer. Similarly, in some cases, the derivative of the information signal is received directly from the filter and is the same as the information signal, while in other cases the derivative of the information signal is a modified version of the information signal provided by the filter.

In some instances, the methods further include electrically coupling a power source to the sigma delta modulator and to the sequencer. In such instances, the sequencer can be operable to assert the capture signal at a predetermined point after activation of the power source. In one particular case, the sequencer includes a counter driven by a clock, and the predetermined point after activation of the power source is a number of clock cycles recognized by the counter. In some cases, the point after activation of the power source is prior to stabilization of the sigma delta modulator. As used herein, the phase “activation of the power source” is used in its broadest sense to mean a period in which the power source begins to provide and/or transfer power.

In various instances of the methods, the filter is a third order decimation filter. In some cases, the derivative of the information signal is derived from an output of a stage of the third order decimation filter. In one such case, the stage of the third order decimation signal is the third stage of the third order decimation filter.

Yet other embodiments of the present invention provide systems for generating random numbers. Such systems include a sigma delta modulator that is electrically coupled to a filter. The filter generates an information signal that is electrically coupled to a memory device. A sequencer is included that generates a capture signal, and the memory device is operable to capture information associated with the information signal based at least in part upon assertion of the capture signal. In some cases, such a system is incorporated in an overall environment. The overall environment may be operable to utilize a random number generated by the system to address a device in which the system is implemented. As such, multiple common devices using the system can be implemented in an overall environment without the need to provide external or programmed address capability.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 are schematic diagrams of a random number generator in accordance with one or more embodiments of the present invention;

FIG. 2 is a flow diagram depicting a method for random number generation in accordance with various embodiments of the present invention;

FIG. 3 is a schematic diagram of a random number generator in accordance with other embodiments of the present invention; and

FIG. 4 is a block diagram of multiple devices each including a random number generator used for establishing a device address with a system controller in accordance with one or more embodiments of the present invention.

### DETAILED DESCRIPTION OF THE INVENTION

The present invention is related to systems and methods for random number generation, and in particular to systems and methods for generating a random number associated with an analog input.

Various embodiments of the present invention provide systems for generating random numbers. Such systems may include an analog to digital conversion element that may include a digital filter. As used herein, the phrase “analog to digital conversion element” is used in its broadest sense to mean any device or circuit that is capable of receiving an analog signal and providing a digital signal that is at least in some way related to the analog signal. Thus, an analog to digital conversion element may include, but is not limited to, a sigma delta modulator, a delta sigma modulator, a summation device associated with an analog to digital converter, a SAR or successive approximation analog to digital converter, a digital filter, and/or the like. In general, such analog to digital conversion elements exhibit operational periods when the digital output is at least somewhat random.

In some cases, the analog to digital conversion element includes a sigma delta modulator electrically coupled to a digital filter. In such cases, the digital filter may provide an information signal based at least in part on an output from the sigma delta modulator. As used herein, the phrase “digital filter” is used in its broadest sense to mean any device or circuit capable of filtering an input, and providing an output where at least the output is in the digital domain. As just one of many examples, a digital filter may be, but is not limited to, a third order decimation filter. As another example, the digital filter may be a simple counter circuit that is gated by a random input such as that provided by a sigma delta modulator operating during an initialization period. Based on the disclosure provided herein, one of ordinary skill in the art will recognize a variety of devices that may be used in relation to one or more embodiments of the present invention. In one particular case of the embodiments, the digital filter is a third order decimation filter and the information signal is derived from the third stage of the filter. Because the third stage is susceptible to greater variance than earlier stages of the filter, it may provide a higher degree of randomness. However, it should be noted that other stages of a third order decimation filter may be used.

In addition, the systems may include a memory device electrically coupled to a sequencer that generates a capture signal. As used herein, the phrase “memory device” is used in its broadest sense to mean any device capable of receiving and at least temporarily storing information. Thus, where, for example, the memory device is a semiconductor memory device, it may be, but is not limited to, a register, one or more latches, one or more flip-flops, one or more DRAM cells, one or more EEPROM cells, one or more NVRAM cells, and/or the like. The memory device is operable to capture information associated with the information signal based at least in part on the capture signal from the sequencer. Thus, for example, in one particular instance of the embodiments, the sequencer asserts the capture signal at a logic ‘1’ state, and at that time the memory device is written with whatever information is available at the interface of the memory device. The sequencer then asserts the capture signal at a logic ‘0’ state, and at that time the previously stored information is maintained in the memory device.

The sequencer and analog to digital conversion element may be electrically coupled to a common power source. As used herein, the phrase “electrically coupled” is used in its broadest sense to mean any coupling whereby an electrical signal may pass between coupled elements either directly by, for example, a metal wire extending between the devices, or indirectly by, for example, passing through an intervening device (which in some cases may result in modification of the electrical signal. Where the sequencer and digital conversion element are electrically coupled to a common power source, the sequencer may be operable to assert the capture signal at a predetermined point after activation of the power source. This may be achieved by, for example, providing a sequencer that includes a counter driven by a clock. The predetermined point after activation of the power source may be a number of clock cycles recognized by the counter, or some range of numbers of clock cycles recognized by the counter. In one particular case, the point after activation of the power source is selected such that the information signal is captured prior to stabilization of the analog to digital conversion element.

Other embodiments of the present invention provide methods for generating random numbers. Such methods may include electrically coupling a filter that generates an information signal to a sigma delta modulator, and electrically coupling the filter to a memory. In addition, the methods include electrically coupling a sequencer that generates a capture signal to the memory. A derivative of the capture signal and a derivative of the information signal may be provided to the memory device, and information associated with the derivative of the information signal is stored in the memory based at least in part on the derivative of the capture signal. As used herein, the term “derivative” when modifying any signal is used in its broadest sense to mean either the original signal, or some modified version of the original signal. Thus, for example, a derivative of the information signal may be the information signal provided by the filter, or the information signal after having been passed through one or more elements that modify the information signal.

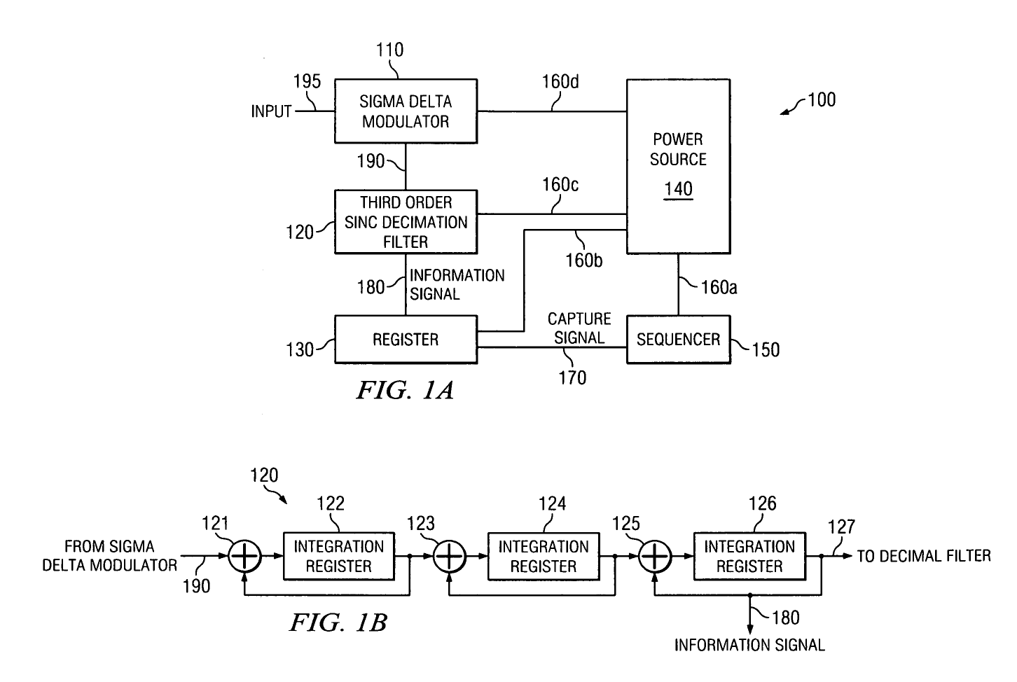

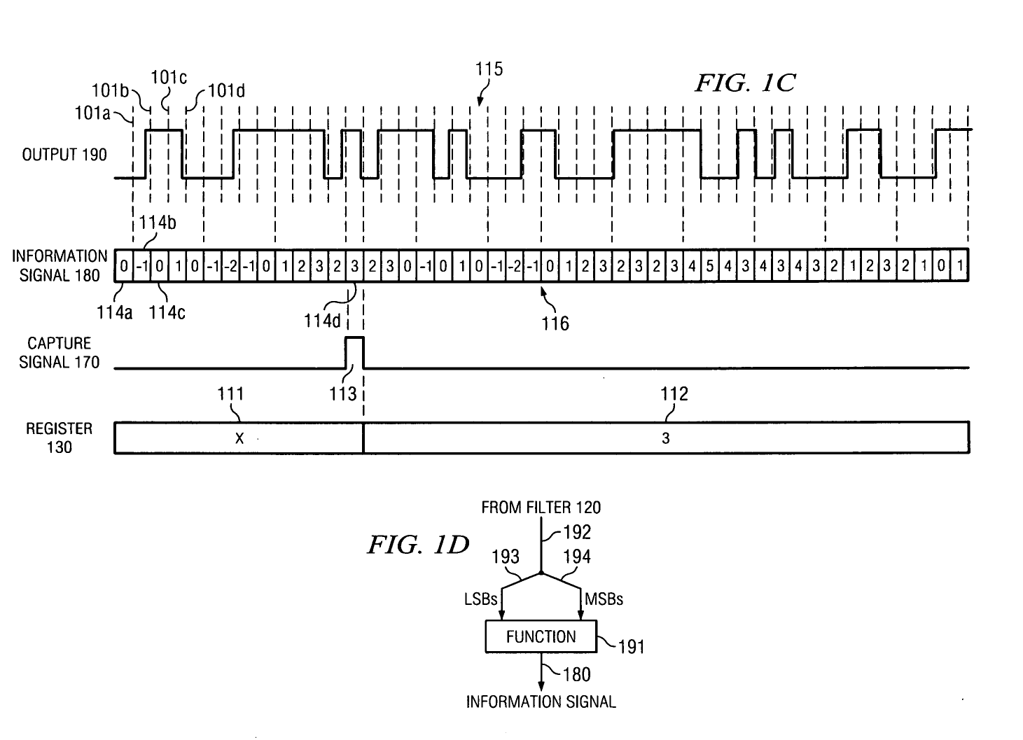

Turning to FIG. 1A, a random number generating system 100 in accordance with one or more embodiments of the present invention is depicted. Random number generating system 100 includes a sigma delta modulator 110 that is electrically coupled to a third order decimation filter 120. In addition, random number generating system 100 includes a register 130 that is electrically coupled to third order decimation filter 120, and a sequencer 150. Register 130 may be any device and/or circuit capable of receiving information and retaining that information. Thus, for example, register 130 may be a group of latches that receive an input value and store the input value when a control signal is asserted at a particular level, or on an edge of a changing control signal or clock. Sequencer 150 is any device and/or circuit that is capable of defining a point in time. Thus, for example, sequencer 150 may be a counter driven by a continuous clock, and the defined point in time may be a number of clock cycles received after random number generating system is powered on. Based on the disclosure provided herein, one of ordinary skill in the art will recognize a variety of devices and/or circuits that may provide the functionality of sequencer 150 and register 130.

Sigma delta modulator 110, third order decimation filter 120, register 130, and sequencer 150 are electrically coupled to a power source 140 via an interconnect 160. Power source 140 may be any mechanism for supplying electrical energy to devices in random number generating system 100. Thus, for example, power source 140 may be a pin on a semiconductor device on which the other elements of random number generating system 100 are implemented. In such a case, interconnect 160 may include a power plane implemented on the semiconductor device. The power plane may, of course, include separate regions for analog and digital portions of the semiconductor device. As another example, power source 140 may be a power supply that is included with a system in which the other elements of random number generating system 100. In such a case, the various elements of random number generating system 100 may be implemented on a semiconductor chip disposed on a circuit board, and interconnect 160 may include one or more circuit board traces capable of delivering electrical energy to the other elements. Based on the disclosure provided herein, one of ordinary skill in the art will appreciate a number of power sources and/or interconnect that may be used in accordance with one or more embodiments of the present invention.

Sigma delta modulator 110 receives an input signal 195 and drives an output 190. Input signal 195 is an analog signal, and output 190 is a digital signal that is based at least in part on input signal 195. Output 190 is provided to third order decimation filter 120, and third order decimation filter 120 drives an information signal 180 that is provided to register 130. In addition, sequencer 150 drives a capture signal 170 that is provided to register 130. As will be appreciated by one of ordinary skill in the art, output 190 from sigma delta modulator I 10 is based on the difference between a sample of analog input signal 195 and a predicted value of that sample. During initialization, no information or energy exists in sigma delta modulator 110 to create an effective predicted value. Thus, during this period, output 190 from sigma delta modulator 110 is substantially unpredictable or random. Over time, the predicted value becomes more effective, and output 190 from sigma delta modulator becomes predictable. Operation when the output of sigma delta modulator is predictable is referred to herein as steady state operation.

FIG. 1B provides a detailed view of a portion of third order decimation filter 120. The portion is a series of integration stages with each integration stage includes an integration register 122, 124, 126 and a summation device 121, 123, 125. In particular, output 190 from sigma delta modulator 110 is provided to summation device 121 where the value of output 190 is summed with the existing value held by integration register 122. In one embodiment of the present invention, where the value provided on output 190 is a ‘0’, one is subtracted from the value held by integration register 122. Alternatively, where the value provided on output 190 is a ‘1’, one is added to the value held by integration register 122. The updated value is then stored to integration register 122. The output of integration register 122 is summed with the value held by integration register 124 using summation device 123, and the resulting value is stored in integration register 124. Similarly, the output of integration register 124 is summed with the value held by integration register 126 using summation device 125, and the resulting value is stored in integration register 126. An output 127 of integration register 126 is provided to another portion (not shown) of third order decimation filter 120. This other portion of third order decimation filter 120 may be, for example, a decimation filter.

As shown, information signal 180 is driven by the third stage of third order decimation filter 120. In one case, information signal 180 is the four least significant bits held by integration register 126. Thus, a random value may be achieved by deriving information signal 180 from the least significant bits of integration register 126. However, it should be noted that information signal 180 may be derived from either of integration register 124, integration register 126, or another register (not shown) within third order filter 120. Where output 190 is random, a degree of randomness may be achieved by using the output of any of the aforementioned registers. Based on the disclosure provided herein, one of ordinary skill in the art will recognize that the entire value of one of integration registers 122, 124, 126; some portion of the value held by one of integration registers 122, 124, 126; or some combination of the values held by integration registers 122, 124, 126 may be provided as information signal 180. Further, based on the disclosure provided herein, one of ordinary skill in the art will recognize that the size of information signal 180 may be any number of bits in width. Thus, while the exemplary embodiment of the present invention is described with information signal 180 as a four bit width word, it may be a single bit, two bits, eight bits, sixteen bits, or any other length.

FIG. 1C is a timing diagram showing an exemplary operation of random number generating system 100. In the exemplary operation, a digital representation of input signal 195 is provided as output 190. Initially, output 190 is a series 115 of ‘1s’ and ‘0s’ provided at a random frequency and with a random duration of the particular ‘1s’ and ‘0s’. As time passes, sigma delta modulator 110 reaches a steady state (not shown) where output 190 is a series of ‘1s’ and ‘0s’ with a pulse width density that is representative of a voltage applied to input signal 195. When sigma delta modulator 110 is operating in the steady state, the frequency and duration of ‘1s’ and ‘0s’ provided as output 190 will change to reflect any change in the voltage applied to input signal 195.

Output 190 is filtered by third order decimation filter 120, and the filtered output 190 is provided as information signal 180. Typically, the filtering of output 190 is synchronized by a clock 101 as indicated by the vertical dashed lines included on FIG. 1C. In one embodiment of the present invention, information signal 180 is equivalent to the least significant bits from integration register 126 of the third stage of third order decimation filter 120. In such an embodiment, the initial value of integration register 126 may be random, or in some cases may be initialized to a particular value on startup. For the purposes of this discussion, it is assumed that the value held by integration register 126 is set to zero (i.e., element 114a) when random number generating system 100 is powered on. In the embodiment, the value maintained by integration register 126 is incremented whenever a logic ‘1’ is detected on output 190, and decremented whenever a logic ‘0’ is detected on output 190. Thus, for example, at the time of clock 101 a, a logic ‘0’ is provided on output 190 and thus the information associated with information signal 180 is decremented from a zero 114a to a negative one 114b. In contrast, a the time of clock 101b, a logic ‘1’ is provided on output 190 and thus the information associated with information signal 180 is incremented from negative one 114b to a zero 114c. This process continues for each of clocks 101. At this juncture, it will be appreciated that where series 115 of ‘1s’ and ‘0s’ is random, information 116 associated with information signal 180 will also be random.

It should be noted that while the least significant bits of integration register 126 are used in the aforementioned exemplary embodiment to create information signal 180, information signal 180 may be derived from other portions of third order decimation filter 120. For example, information associated with information signal 180 may be the entire output from one of the other integration registers 124, 126 of third order decimation filter 120, a portion of the output of one of the other stages or third order decimation filter 120, or a combination of outputs from various stages of third order decimation filter 120. Further, information associated with information signal 180 may be taken from a decimation portion (not shown) of third order decimation filter 120. In some cases, however, it may be desirable to utilize the least significant bits of integration register 126 as those bits may change at the greatest frequency. Based on the disclosure provided herein, one of ordinary skill in the art will recognize a variety of stages from which information associated with information signal 180 may be derived.

Sequencer 150 determines a point in time after random number generating system 150 is powered on. When the determined point in time occurs, capture signal 170 is asserted (i.e., pulse 113) causing register 130 to latch the information associated with information signal 180. As previously discussed, in some cases capture signal 170 is asserted after sequencer 150 recognizes a particular number of clocks 101. In this case, where it is assumed that power to sequencer 150 was sufficiently stable that it could recognize all depicted clocks 101, the number of clocks designating the particular point in time is fourteen. Based on the disclosure provided herein, however, one of ordinary skill in the art will recognize that this number of clocks is merely exemplary, and that a great variety of clock counts may be selected in accordance with one or more embodiments of the present invention. Further, based on the disclosure provided herein, one of ordinary skill in the art will recognize a variety of methods for identifying a point in time after power up where a random number is accessed. For example, the number of clocks to wait after power up may be a delta from a fixed count, with the delta being a random number derived from another of the integration registers. More particularly, a fixed number of clocks may cause a first random number to be accessed from, for example, integration register 122. This first random number indicates a number of additional clock cycles that are counted before a second random number is accessed from, for example, integration register 126. Thus, a potentially higher degree of randomness may be achieved. One of ordinary skill in the art will appreciate that implementing such an approach may involve communication between filter 120 and sequencer 150 that is not shown in FIG. 1A.

In some cases, the point in time where the final random number is accessed is selected to be point in time before sigma delta modulator 110 achieves steady state operation. As previously suggested, before sigma delta modulator 110 achieves steady state operation, output 190 is random. Thus, it may often be desirable to select a number of clocks less than that required for sigma delta modulator to reach a steady state operation.

Pulse 113 is received by register 130. Based on pulse 113, information 114d associated with information signal 180 is stored in register 130. This change in register 130 is represented by showing information 114d as element 112. Before capture signal 170 is asserted, register 130 may be undefined as indicated by an ‘X’ in an element 111. It should be noted, however, that register 130 maybe initialized to some value in which case it would not be undefined. Where capture signal 170 is asserted at a point in time that output 190 is random, information stored in register 130 will be random, and this information may serve effectively as a random number.

Turning to FIG. 1D, an alternative approach is shown that may be used for indirectly generating information signal 180 in accordance with one or more embodiments of the present invention. In contrast to the approach that was described in relation to FIG. 1B where information signal 180 is directly taken from an existing output of third order decimation filter 120, a signal 192 may be taken from third order decimation filter 120 and passed through a function 191 to generate information signal 180. In the illustrated example, the most significant bits 194 and the least significant bits 193 from signal 192 may be passed separately to function 191 that somehow combines most significant bits 194 and least significant bits 193 to generate information signal 180. As one of many example, function 191 XORs the most significant bits 194 with least significant bits 193 to generate information signal 180. One of ordinary skill in the art will appreciate a variety of functions that can be applied to one or more outputs of third order decimation filter 120 to create a particular information signal 180. Further, based on the disclosure provided herein, one of ordinary skill in the art will recognize that information signal 180 maybe driven directly by one or more stages of third order decimation filter 120, or indirectly by, for example, a function such as that depicted in FIG. 1D.

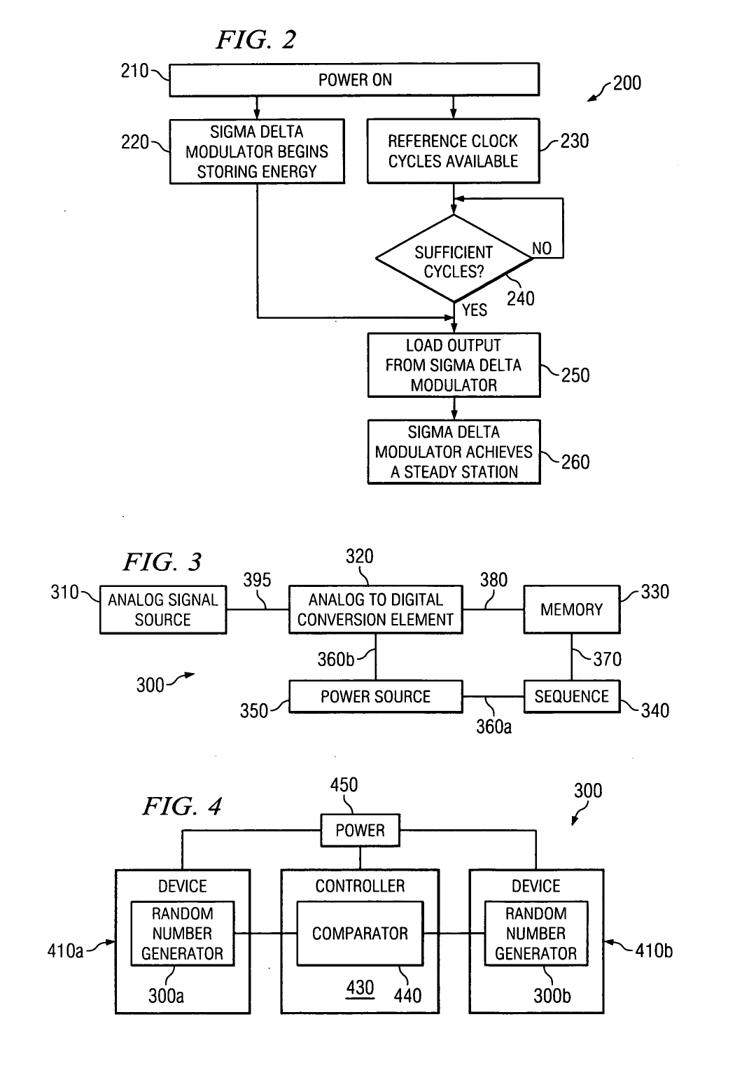

Turning to FIG. 2, a flow diagram 200 depicts a method for random number generation in accordance with various embodiments of the present invention. Following flow diagram 200, a device including a random number generation system in accordance with an embodiment of the present invention is powered on (block 210). The random number generator includes a sigma delta modulator, a sequencer, and a memory that each begin to receive power at the point the device is powered on. In some cases, the power is received almost simultaneously by the sigma delta modulator, the decimation filter, the sequencer, and the memory, while in other cases the power distribution is somewhat staggered between the devices. In general, after receiving power, the memory, the decimation filter, and sequencer will achieve steady state (i.e., predictable) operation before sigma delta modulator. Upon receiving power, the sigma delta modulator begins storing energy (block 220). During this period, the output of the sigma delta modulator is highly erratic and unpredictable (i.e., random) as exemplified by output 190 depicted in FIG. 1C.

Also, at some time shortly after receiving power, a clock used to synchronize operations of the device including the random number generating system begins producing recognizable clock pulses (block 230). These clock pulses are provided to the sequencer. The sequencer counts the received clock pulses and compares the counted clock pulses with a predetermined number (block 240). As previously discussed, the predetermined number of clocks may be set such that it is reached during the period when the sigma delta modulator is still producing a random output (i.e., before the sigma delta modulator achieves a steady state operation). Once sufficient clock pulses have been received (block 240), the sequencer indicates such and a value derived from the output of the sigma delta modulator is stored to the memory (block 250). As this value is stored before the sigma delta modulator achieves a steady state operation, it is random. This value, or some modification thereof, can then be used as a random number output from the random number generator. At some point after the value is stored to the memory, the sigma delta modulator achieves a steady state (block 260).

Turning to FIG. 3, a random number generator 300 in accordance with other embodiments of the present invention is illustrated. Random number generator 300 includes an analog signal source 310 that provides an analog input signal 395 to an analog to digital conversion element 320. Analog signal source 310 maybe any analog source. Thus, for example, analog signal source 310 may be an acceleration module on a car, a radio frequency (“RF”) signal receiver source, and/or the like. Based on the disclosure provided herein, one of ordinary skill in the art will recognize a myriad of analog signal sources and associated analog signals that may be used in relation to embodiments of the present invention.

Analog to digital conversion element 320 receives analog signal 395 and produces an information signal 380 that is a digital signal derived from or in some way related to analog signal 395. As just one example, analog to digital conversion element may include a sigma delta modulator driving a counter. In such a case, the counter may be implemented to count clock cycles occurring whenever the output of the sigma delta modulator is asserted at a particular logic level. Alternatively, the digital output of the sigma delta modulator may be used as a clock to the counter to further randomize the count. Thus, where the output of the sigma delta modulator is random, the count provided by the counter will also be random. Random number generator 300 also includes a sequencer 340 and a memory 330. Memory 330 may be any device and/or circuit capable of receiving information and retaining that information. Thus, for example, memory 330 may be a group of latches that receive an input value and store the input value when a control signal is asserted at a particular level, or on an edge of a changing control signal or clock. Sequencer 340 may be any device and/or circuit that is capable of defining a point in time. Thus, for example, sequencer 340 may be a counter driven by a continuous clock, and the defined point in time may be a number of clock cycles received after random number generating system is powered on. Based on the disclosure provided herein, one of ordinary skill in the art will recognize a variety of devices and/or circuits that may provide the functionality of sequencer 340 and memory 330.

Random number generator 300 also includes a power source 350 that is coupled to at least analog to digital conversion element 320 and to sequencer 340 via an interconnect 360. Similar to the previously described power source 140 and interconnect 160, power source 350 may be any mechanism for supplying electrical energy to other devices in random number generator 300. Thus, for example, power source 350 may be a pin on a semiconductor device on which the other elements of random number generator 300 are implemented. In such a case, interconnect 360 may include a power plane implemented on the semiconductor device. The power plane may, of course, include separate regions for analog and digital portions of the semiconductor device. As another example, power source 350 may be a power supply that is included with a system in which the other elements of random number generator 300. In such a case, the various elements of random number generator 300 may be implemented on a semiconductor chip disposed on a circuit board, and interconnect 360 may include one or more circuit board traces capable of delivering electrical energy to the other elements. As with the previous discussion of power source 140 and interconnect 160, one of ordinary skill in the art will appreciate a number of power sources and/or interconnect that may be used in accordance with one or more embodiments of the present invention.

In operation, electrical power is initially introduced by power source 350 to analog to digital conversion element 320 and sequencer 340 via interconnect 360. At initialization, analog to digital conversion element 320 produces a highly random output that is used to generate information signal 380. This results in a series of random values associated with information signal 380 for at least the period of initialization (i.e., the period proceeding from power on until analog to digital conversion element achieves a steady state operation). Upon initialization, sequencer 340 begins counting system clock cycles. Once a predetermined number of system clock cycles have been achieved, sequencer 340 asserts a capture signal 370. As previously discussed, the predetermined number of system clock cycles may be selected such that it represents a point in time somewhere between initialization of analog to digital conversion element 320, and steady state operation of analog to digital conversion element 320. During this period, information signal 380 is random. Upon assertion of capture signal 370, the random information associated with information signal 380 is stored in memory 330. This stored random information serves as a random number that can be provided by random number generator 300.

Turning to FIG. 4, an overall environment 400 is depicted including multiple devices with random number generators used for establishing a device address with a system controller is depicted. More specifically, overall environment 400 includes two devices 410 that each include a random number generator 300. Upon initially receiving power 450, each random number generator 300 produces a random number and provides that random number to a controller 430. These random numbers may then be used to address devices 410 during operation of overall environment 400. To avoid the possibility that both random number generators 300 provide the same random number which would cause a problem with addressing devices 410, controller 430 includes a comparator 440. Where comparator 440 indicates that received random numbers are identical, power to overall environment 400 is cycled and the process is repeated.

The invention has now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for generating random numbers, the system comprising:
a sigma delta modulator, wherein the sigma delta modulator provides an output;
a filter, wherein the filter is electrically coupled to the sigma delta modulator, and wherein the filter generates an information signal based on the output;
a sequencer, wherein the sequencer generates a capture signal; and
a memory device, wherein the memory device is electrically coupled to the capture signal and the information signal, and wherein the memory device captures information associated with the information signal based at least in part on the capture signal.

2. The system of claim 1, wherein the filter is a third order decimation filter.

3. The system of claim 1, wherein the filter is a third order decimation filter.

4. The system of claim 3, wherein the stage of the third order decimation signal is the third stage of the third order decimation filter.

5. The system of claim 1, wherein the system further comprises:
a power source electrically coupled to the sigma delta modulator and the sequencer, wherein the sequencer is operable to assert the capture signal at a predetermined point after activation of the power source.

6. The system of claim 5, wherein the sequencer includes a counter driven by a clock, and wherein the predetermined point after activation of the power source is a number of clock cycles recognized by the counter.

7. The system of claim 5, wherein the point after activation of the power source is prior to stabilization of the sigma delta modulator.

8. A method for generating random numbers, the method comprising:
electrically coupling a filter to a sigma delta modulator, wherein the filter generates an information signal;
electrically coupling the filter to a memory;
electrically coupling a sequencer to the memory, wherein the sequencer generates a capture signal;
providing a derivative of the capture signal and a derivative of the information signal to the memory device; and
based at least in part on the derivative of the capture signal, capturing information associated with the derivative of the information signal in the memory device.

9. The method of claim 8, wherein the derivative of the information signal is the same as the information signal.

10. The method of claim 8, wherein the derivative of the capture signal is the same as the capture signal.

11. The method of claim 8, wherein the method further comprises:
electrically coupling a power source to the sigma delta modulator and to the sequencer, wherein the sequencer is operable to assert the capture signal at a predetermined point after activation of the power source.

12. The method of claim 11, wherein the sequencer includes a counter driven by a clock, and wherein the predetermined point after activation of the power source is a number of clock cycles recognized by the counter.

13. The method of claim 11, wherein the point after activation of the power source is prior to stabilization of the sigma delta modulator.

14. The method of claim 8, wherein the filter is a third order decimation filter.

15. The method of claim 14, wherein the derivative of the information signal is derived from an output of a stage of the third order decimation filter.

16. The method of claim 15, wherein the stage of the third order decimation signal is the third stage of the third order decimation filter.

17. A system for generating random numbers, the system comprising:
an analog to digital conversion element, wherein the analog to digital conversion element provides an information signal;
a sequencer, wherein the sequencer generates a capture signal at a point in time when information associated with the information signal is random; and
a memory device electrically coupled to the capture signal, wherein the memory device is electrically coupled to the information signal, and wherein the memory device captures information associated with the information signal based at least in part on the capture signal.

18. The system of claim 17, wherein the analog to digital conversion element includes a sigma delta modulator.

19. The system of claim 18, wherein the analog to digital conversion element further includes a digital filter, wherein the digital filter is a third order decimation filter, and wherein the information signal is derived from an output of a stage of the third order decimation filter.

20. The system of claim 17, wherein the system is incorporated in an overall environment, and wherein the overall environment is operable to utilize a random number generated by the system to address a device in which the system is implemented.
